(19) United States
(12) Patent Application Publication
(10) Pub. No.: US 2014/0323220 A1
(43) Pub. Date: Oct. 30, 2014

(54) GAME CONTROLLER

(71) Applicant: CHENG UEI PRECISION INDUSTRY CO., LTD., New Taipei City (TW)

(72) Inventor: Tsung Shih Lee, New Taipei City (TW)

(73) Assignee: Cheng Uei Precision Industry Co., Ltd., New Taipei City (TW)

(21) Appl. No.: 13/870,334

(22) Filed: Apr. 25, 2013

(51) Int. Cl. A63F 13/20

(52) U.S. Cl. CPC A63F 13/06
USPC 463/37

(57) ABSTRACT

A game controller includes a lower shell, an upper shell matched with the lower shell for receiving magnets therein and defining a battery-holding chamber, and a top cover removably attached on the upper shell to cover the battery-holding chamber. A bottom side of the upper shell protrudes downward to form at least one positioning pillar sheathed with a rubber sleeve of which an inside wall defines a first fixing structure. A through aperture extends vertically to penetrate through the positioning pillar and the upper shell. A bottom side of the top cover protrudes downward to form a fixing pillar of which a lower part defines a second fixing structure. The fixing pillar passes through the through aperture to be inserted in the rubber sleeve, and the first fixing structure is snapped with the second fixing structure. The top cover is equipped with metal blocks attracted with the magnets.

### BACKGROUND OF THE INVENTION

1. Field of the Invention

The present invention relates to a controller, and more particularly to a game controller.

2. The Related Art

A game controller is usually connected to a game console or computer, and is a device used with games or entertainment systems to provide input to a video game, typically to control an object or character in the game. The game controller generally includes a shell, an electronic circuit module received in the shell, and a plurality of buttons assembled in the shell and electrically connected with the electronic circuit module for operating the game controller. In order to meet the requirement of increasing miniaturization of electronic products, at present, the shell of the game controller is often acted as a cover for covering a battery-holding chamber in the game controller.

In detail, the shell of the game controller includes two top covers, an upper shell and a lower shell. The upper shell and the lower shell are matched with each other to receive a plurality of magnets therein. The top covers are equipped with a plurality of metal blocks. The upper shell defines a plurality of through holes. The top covers are attached on two sides of a top face of the upper shell by virtue of the magnets and the metal blocks being attracted with one another through the through holes respectively. The upper shell defines the battery-holding chambers for receiving batteries therein. The top covers are further used to cover the battery-holding chambers.

However, the top covers are attached on the upper shell only by means of the attraction of the magnets and the metal blocks, so that causes a great quantity of magnets and metal blocks to be required and further results in a high manufacture cost of the game controller. Moreover, a relative movement is apt to happen about the top covers and the upper shell in the case of a severe shaking Therefore, a game controller capable of overcoming the foregoing problems is required.

### SUMMARY OF THE INVENTION

It is an object of the present invention to provide a game controller which includes a lower shell, an upper shell and at least one top cover. The upper shell is matched with the lower shell for receiving a plurality of magnets therein. The upper shell defines at least one battery-holding chamber. A bottom side of the upper shell protrudes downward to form at least one positioning pillar. A through aperture extends vertically to penetrate through the positioning pillar and the upper shell. The positioning pillar is sheathed with a rubber sleeve of which an inside wall defines a first fixing structure. The top cover is removably attached on a top face of the upper shell to cover the battery-holding chamber. A bottom side of the top cover protrudes downward to form a fixing pillar of which a lower part defines a second fixing structure fit in with the first fixing structure of the rubber sleeve. The fixing pillar passes through the through aperture to be inserted in the rubber sleeve, and the first fixing structure is snapped with the second fixing structure. The top cover is equipped with a plurality of metal blocks attracted with the magnets respectively.

As described above, the game controller of the present invention utilizes dual cooperation of the fixing pillar of the top cover passing through the through aperture of the upper shell to be inserted in the rubber sleeve and snap the second fixing structure with the first fixing structure, and the magnets and the metal blocks being attracted with one another respectively, to effectively strengthen the assembly of the top cover and the upper shell. So that not only cuts down on the cost of using magnets and metal blocks, but also achieves a relative stability of assembly of the top cover and the upper shell even in the case of a severe shaking Furthermore, the rubber sleeve is made of rubber material, so it is difficult to be worn with the fixing pillar of the top cover even after the repeated insertion and extraction, so that further achieves a durable and convenient way of opening and closing the top cover with respect to the upper shell.

### BRIEF DESCRIPTION OF THE DRAWINGS

The present invention will be apparent to those skilled in the art by reading the following description, with reference to the attached drawings, in which:

FIG. 1 is an assembled perspective view of a game controller in accordance with an embodiment of the present invention;

FIG. 2 is an exploded perspective view of the game controller of FIG. 1;

FIG. 3 is an assembled perspective view of an upper shell and two top covers of the game controller shown in FIG. 2;

FIG. 4 is an assembled sectional view of the upper shell and the top covers shown in FIG. 3;

FIG. 5 is an enlarged view of a circled part shown in FIG. 4; and

FIG. 6 is a cross-sectional view of a rubber sleeve of the game controller of FIG. 1.

### DETAILED DESCRIPTION OF THE PREFERRED EMBODIMENT

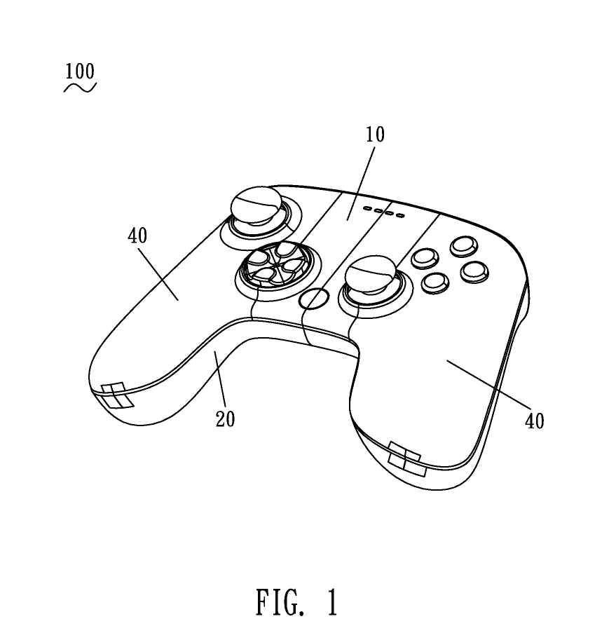

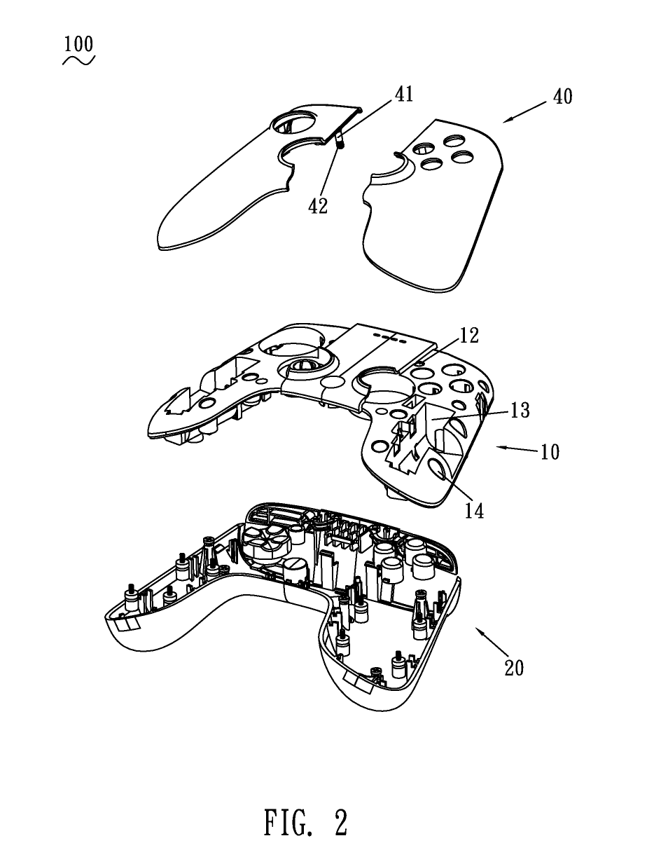

With reference to FIG. 1 and FIG. 2, a game controller 100 according to an embodiment of the present invention includes an upper shell 10, a lower shell 20 matched and fixed with the upper shell 10 for receiving an electronic circuit module (not shown) and a plurality of magnets (not shown) therein, and two top covers 40 removably attached on two sides of a top face of the upper shell 10.

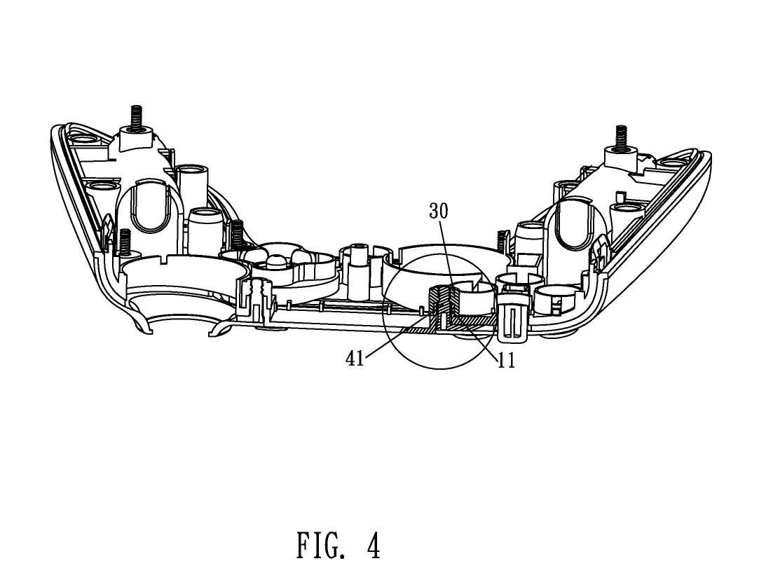

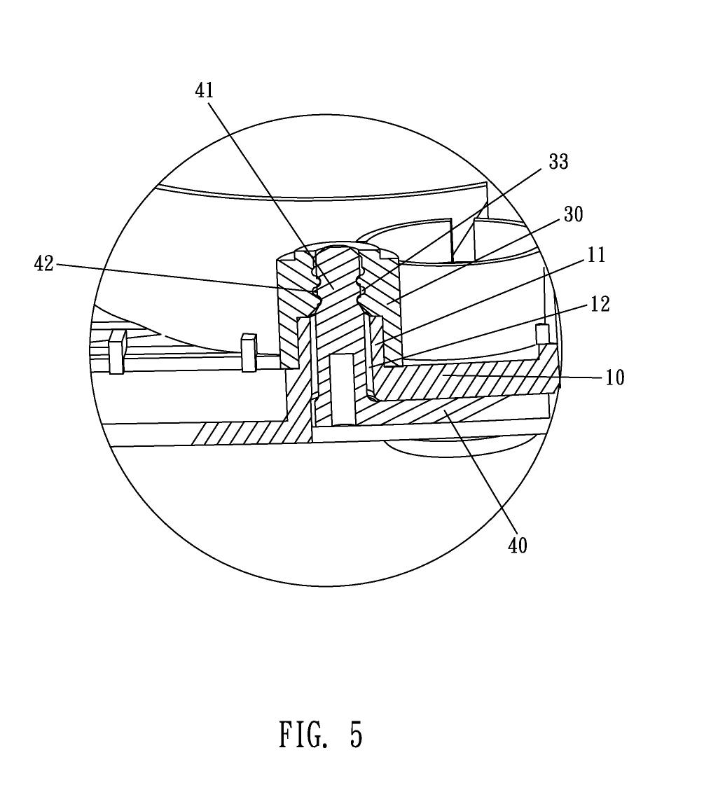

Referring to FIG. 2, FIG. 4 and FIG. 5, the upper shell 10 is substantially of lying-U shape and defines two battery-holding chambers 13 at two sides thereof for receiving external batteries therein, wherein the batteries are used to supply power for the game controller 100. A bottom side of the upper shell 10 protrudes downward to form two positioning pillars 11 of which each defines a through aperture 12 vertically extending to penetrate through the positioning pillar 11 and the upper shell 10. The upper shell 10 defines a plurality of through holes 14, and the magnets received between the upper shell 10 and the lower shell 20 are disposed corresponding to the through holes 14 and exposed through the through holes 14 respectively.

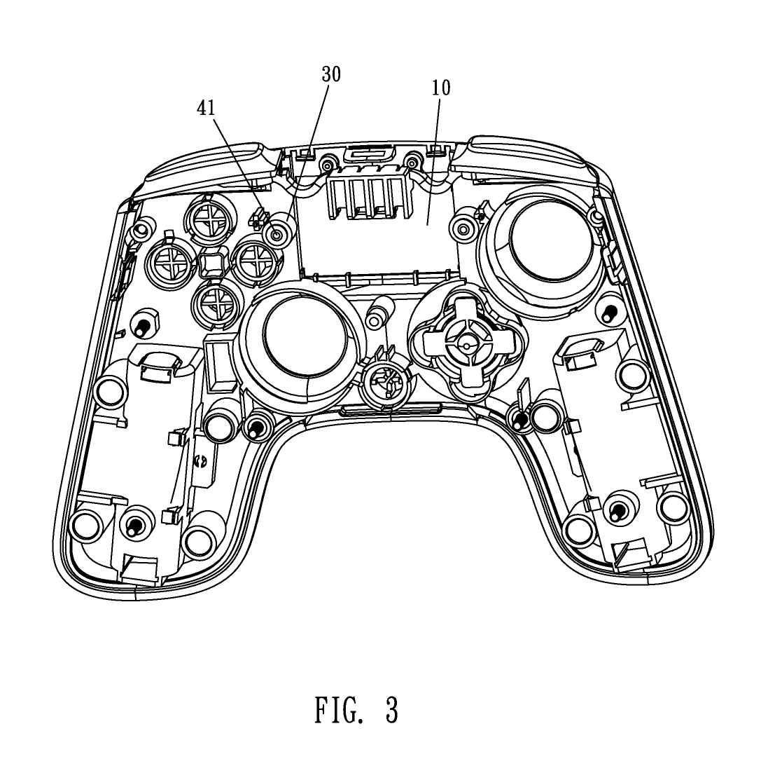

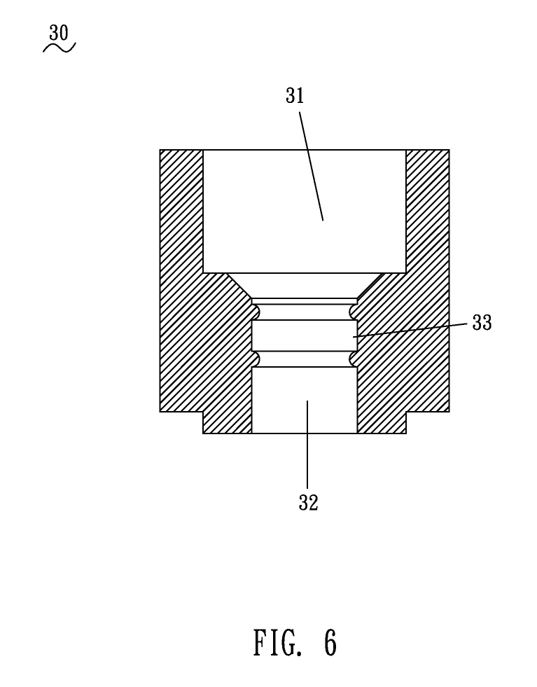

Referring to FIG. 3, FIG. 4, FIG. 5 and FIG. 6, the positioning pillars 11 of the upper shell 10 are sheathed with a rubber sleeve 30 respectively. The rubber sleeve 30 is made of rubber material and is of cylindrical shape. The rubber sleeve 30 defines a fastening aperture 31 at one end thereof and a fixing hole 32 at the other end thereof. The fixing hole 32 is communicated with and coaxial with the fastening aperture 31, and has a smaller diameter than the fastening aperture 31. The inside wall of the fixing hole 32 defines a first fixing structure 33. In this embodiment, the first fixing structure 33 is a plurality of ring-shaped fixing grooves arranged coaxially and apart. The rubber sleeve 30 is sleeved around the positioning pillar 11 of the upper shell 10 by virtue of the positioning pillar 11 being fastened in the corresponding fastening aperture 31, with the fixing hole 32 being coaxial and communicated with the corresponding through aperture 12.

Referring to FIGS. 2-6, a bottom side of each of the top covers 40 protrudes downward to form a fixing pillar 41 of which a lower part defines a second fixing structure 42 fit in with the first fixing structure 33 of the rubber sleeve 30. In this embodiment, the second fixing structure 42 is made of rubber material and is a plurality of ring-shaped fixing ribs apart protruded around the outside of the lower part of the fixing pillar 41. The top covers 40 are equipped with a plurality of metal blocks (not shown). The top covers 40 are removably attached on two sides of the top face of the upper shell 10 to cover the battery-holding chambers 13 respectively, by virtue of the magnets and the metal blocks being attracted with one another through the through holes 14 respectively. The fixing pillar 41 passes through the corresponding through aperture 12 to be inserted in the fixing hole 32 of the rubber sleeve 30, and the first fixing structure 33 is snapped with the second fixing structure 42 to further strengthen the assembly of the top cover 40 and the upper shell 10. When the battery in the battery-holding chamber 13 of the upper shell 10 needs to be replaced, just open the corresponding top cover 40 to separate the magnets from the metal blocks and extract the fixing pillar 41 from the fixing hole 32 of the rubber sleeve 30.

As described above, the game controller 100 of the present invention utilizes dual cooperation of the fixing pillar 41 of the top cover 40 passing through the through aperture 12 of the upper shell 10 to be inserted in the fixing hole 32 and snap the second fixing structure 42 with the first fixing structure 33 of the rubber sleeve 30, and the magnets and the metal blocks being attracted with one another through the through holes 14 respectively, to effectively strengthen the assembly of the top covers 40 and the upper shell 10. So that not only cuts down on the cost of using magnets and metal blocks, but also achieves a relative stability of assembly of the top cover 40 and the upper shell 10 even in the case of a severe shaking Furthermore, the rubber sleeves 30 and the fixing pillars 41 of the top covers 40, especially the first fixing structure 33 and the second fixing structure 42 are made of rubber material, so they are difficult to be worn with each other even after the repeated insertion and extraction, so that further achieves a durable and convenient way of opening and closing the top covers 40 with respect to the upper shell 10.

What is claimed is:

1. A game controller, comprising:
a lower shell;
an upper shell matched with the lower shell for receiving a plurality of magnets therein, the upper shell defining at least one battery-holding chamber, a bottom side of the upper shell protruding downward to form at least one positioning pillar, a through aperture extending vertically to penetrate through the positioning pillar and the upper shell, the positioning pillar being sheathed with a rubber sleeve of which an inside wall defines a first fixing structure; and
at least one top cover removably attached on a top face of the upper shell to cover the battery-holding chamber, a bottom side of the top cover protruding downward to form a fixing pillar of which a lower part defines a second fixing structure fit in with the first fixing structure of the rubber sleeve, the fixing pillar passing through the through aperture to be inserted in the rubber sleeve, and the first fixing structure being snapped with the second fixing structure, the top cover being equipped with a plurality of metal blocks attracted with the magnets respectively.

2. The game controller as claimed in claim 1, wherein the rubber sleeve defines a fastening aperture at one end thereof and a fixing hole at the other end thereof, the fixing hole is communicated with and coaxial with the fastening aperture and has a smaller diameter than the fastening aperture, the rubber sleeve is sleeved around the positioning pillar of the upper shell by virtue of the positioning pillar being fastened in the fastening aperture with the fixing hole being coaxial and communicated with the through aperture, the inside wall of the fixing hole defines the first fixing structure, the fixing pillar of the top cover passes through the through aperture to be inserted in the fixing hole of the rubber sleeve.

3. The game controller as claimed in claim 2, wherein the first fixing structure is a plurality of ring-shaped fixing grooves arranged coaxially and apart, the second fixing structure is a plurality of ring-shaped fixing ribs apart protruded around the outside of the lower part of the fixing pillar and snapped with the fixing grooves of the rubber sleeve.

4. The game controller as claimed in claim 1, wherein the first fixing structure is a plurality of ring-shaped fixing grooves arranged coaxially and apart, the second fixing structure is a plurality of ring-shaped fixing ribs apart protruded around the outside of the lower part of the fixing pillar and snapped with the fixing grooves of the rubber sleeve.

5. The game controller as claimed in claim 1, wherein the second fixing structure of the fixing pillar of the top cover is made of rubber material.

6. The game controller as claimed in claim 1, wherein the upper shell defining a plurality of through holes, the magnets received between the upper shell and the lower shell are disposed corresponding to the through holes and exposed through the through holes, the metal blocks of the top cover are attracted with the magnets through the through holes respectively.
